(19) United States
(12) Patent Application Publication
(10) Pub. No.: US 2003/0144393 A1
(43) Pub. Date: Jul. 31, 2003

(54) Functionalised silane-based compounds, methods for producing them and their use in the area of rubber materials

(76) Inventors: Pierre Barruel, Tassin La Demi-Lune (FR); Elisabeth Bourgeois, Villeurbanne (FR); Nathalie Guennouni, Irigny (FR); Pierre Luciani, Lyon (FR); Gerard Mignani, Lyon (FR); Herve Parisot, Caluire (FR)

Correspondence Address: BURNS DOANE SWECKER & MATHIS L L P, POST OFFICE BOX 1404, ALEXANDRIA, VA, 22313-1404, US

(21) Appl. No.: 10/168,973

(22) PCT Filed: Dec. 22, 2000
(86) PCT No.: PCT/FR00/03666

(30) Foreign Application Priority Data
Dec. 30, 1999 (FR) 99 16710
Jun. 16, 2000 (FR) 00 07701

(51) Int. Cl. C08K 5/24; C08K 3/18; C07F 7/04; C08K 3/34

(52) U.S. Cl. 524/261; 524/492; 524/430; 556/450

(57) ABSTRACT

The invention relates first to compounds consisting essentially of a functionalised organosilane of formula (R¹O)ₐ(R²)₃₋ₐSiZ, wherein R¹ and R² are monovalent hydrocarbonated groups, a is a number chosen from 1, 2 and 3 and Z is a function containing an activated ethylenic double bond, chosen from the following:an ester-maleamic function and/or an ester-fumaramic function. The invention also relates to methods for producing said compounds, and to their use as white filler-elastomer coupling agents in rubber compositions containing a white filler, especially a siliceous white filler, as a reinforcing filler.

The present invention relates to novel compounds based on functionalized silanes, to processes for preparing them and to their use as white-filler/elastomer coupling agents in rubber compositions comprising a white filler, especially a siliceous material, as reinforcing filler.

Compounds based on functionalized silanes, relating to the context of the first subject of the invention, are compounds essentially consisting of organosilanes each carrying a maleamic ester functional group or a fumaramic ester functional group. These functional groups, which comprise an ethylenic double bond activated by CO groups lying in the α and β positions of the double bond, give the organosilane compounds specific properties which allow them to be used advantageously as white-filler/elastomer coupling agents in rubber compositions comprising a white filler as reinforcing filler.

More specifically, a first subject of the present invention relates to compounds essentially consisting of a functionalized organosilane of formula:

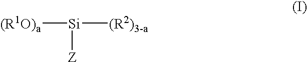

in which:

the symbols R¹, which are identical or different, each represent a monovalent hydrocarbon group chosen from: a linear or branched alkyl radical having from 1 to 4 carbon atoms; a linear or branched alkoxyalkyl radical having from 2 to 6 carbon atoms; a cycloalkyl radical having from 5 to 8 carbon atoms; and a phenyl radical;

the symbols R², which are identical or different, each represent a monovalent hydrocarbon group chosen from: a linear or branched alkyl radical having from 1 to 6 carbon atoms; a cycloalkyl radical having from 5 to 8 carbon atoms; and a phenyl radical;

Z is a functional group, comprising an activated ethylenic double bond, chosen from:

a maleamic ester functional group Z² of formula:

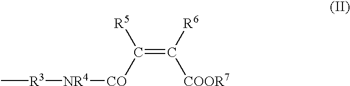

and a fumaramic ester functional group Z³ of formula:

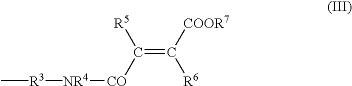

in which formulae:

R³ is a divalent, linear or branched, alkylene hydrocarbon radical having from 1 to 10 carbon atoms, possibly interrupted by at least one oxygen-substituted heteroatom whose free valence carried by a carbon atom is linked to the Si atom;

the symbols R⁴, R⁵ and R⁶, which are identical to or different from one another, each represent a hydrogen atom or a monovalent hydrocarbon group chosen from: a linear or branched alkyl radical having from 1 to 6 carbon atoms; and a phenyl radical;

R⁷ is a monovalent hydrocarbon group chosen from: a linear or branched alkyl radical having from 1 to 6 carbon atoms; and a phenyl radical;

a is a number chosen from 1, 2 and 3.

As indicated above, the present invention, according to its first subject, relates to compounds essentially consisting of a functionalized organosilane of formula (I). The term “essentially” should be interrupted as meaning that the functionalized organosilane used within the context of the present invention may be in the form of a functionalized organosilane of formula (I) in the pure state or in the form of a mixture of a like organosilane with a variable molar amount, generally of less than or equal to 40 mol % in the mixture, of one or more other organosiliceous compounds, comprising:

in an amount generally less than or equal to 10 mol %: the functionalized organosilane of formula (I) which is the isomer of the organosilane essentially obtained, that is to say the trans organosilane of formula (I) where Z is the functional group Z³ of formula (III), when the organosilane essentially obtained is the cis organosilane of formula (I) where Z is the functional group Z² of formula (II), and vice versa; and/or

in an amount generally less than or equal to 30 mol %: at least one linear, cyclic and/or networked siloxane oligomer formed from units satisfying the following formulae: (R⁸)₂ZSiO_{1/2} (IV-1), R⁸ZSiO_{2/2} (IV-2) and/or ZSiO_{3/2} (IV-3), in which: the symbols R⁸, which are identical or different, each represent a monovalent radical chosen from the hydroxyl radical and/or the radicals satisfying the definitions of OR¹ and R²; the symbols R¹, R² and Z are as defined above; and the total number of units of formulae (IV-1) to (IV-3), per oligomer molecule, is an integer or fractional number greater than 1, preferably ranging from 2 to a value of less than 3. The abovementioned molar quantity is expressed as the number of Si atoms (or of organosiliceous units) belonging to the other organosiliceous compound(s) per 100 Si atoms present in the total mixture. To the knowledge of the Applicant, such siloxane oligomers are novel products which form another aspect of the present invention according to its first subject.

The amount of organosiliceous compound(s) will essentially vary according to the operating conditions for carrying out the processes that can be used for preparing the functionalized organosilane of formula (I). When the aim is a mixture of products, if it is desired to be able to have a purified functionalized organosilane of formula (I) or one in the pure state, a purification step is carried out, for example by distillation under reduced pressure or by liquid chromatography.

In the above formulae, the preferred radicals R¹ are chosen from the radicals: methyl, ethyl, n-propyl, isopropyl, n-butyl, CH₃OCH₂—, CH₃OCH₂CH₂—, CH₃OCH(CH₃)CH₂—; more preferably, the radicals R¹ are chosen from the radicals: methyl, ethyl, n-propyl and isopropyl. The preferred radicals R² are chosen from the radicals: methyl, ethyl, n-propyl, isopropyl, n-butyl, n-pentyl, cyclohexyl and phenyl; more preferably, the radicals R² are methyls.

The functional groups represented by the symbol Z are preferably chosen from the functional groups of formulae (II) and (III), in which:

the symbol R³ represents an alkylene residue which satisfies the following formulae: —(CH₂)₂—, —(CH₂)₃—, —(CH₂)₄—, —CH₂—CH(CH₃)—, —(CH₂)₂—CH (CH₃)—(CH₂)—, —(CH₂)₃—O—(CH₂)₃— and —(CH₂)₃—O—CH₂—CH(CH₃)—(CH₂)—; more preferably, R³ is a —(CH₂)₂— or —(CH₂)₃— residue;

the symbols R⁴, R⁵ and R⁶ are chosen from: a hydrogen atom, and methyl, ethyl, n-propyl and n-butyl radicals; more preferably, these symbols are chosen from a hydrogen atom and a methyl radical;

the symbol R⁷ is chosen from methyl, ethyl, n-propyl and isopropyl radicals; more preferably, R⁷ is a methyl.

Typical functionalized organosilanes satisfying formula (I) are those of formula:

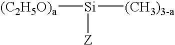

where:

a is a number equal to 2 or 3,

the symbol Z satisfies the following formulae (II) and (III):

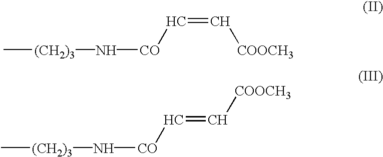

The compounds according to the invention, essentially consisting of functionalized organosilanes of formula (I), may be prepared, and it is this which constitutes the second subject of the present invention, by applying various synthesis processes.

According to a first process, the compounds according to the invention may be prepared by the esterification of the intermediate maleamic acid derivative by carrying out the following steps: (1) the reaction of coupling between an aminosilane 1 and the maleamic anhydride 2, and then (2) the reaction of esterification of the maleamic acid derivative formed 3 so as to result in the compound essentially consisting of the desired functionalized organosilane 4, by applying the following synthesis scheme:

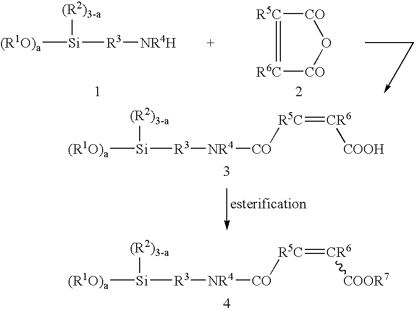

With regard to the practical way of implementing steps (1) and (2), reference may be made for further details to the contents of the following documents which describe, possibly starting with other reactants, operating methods that can be applied to the execution of the various steps of the process in question:

for step (1): cf. especially Izvestiya Akademii Nauk SSSR, 11, pages 2538-43, 1970;

for step (2), where several operating methods are applicable:

(i) the reaction of the ammonium salt of the carboxylic acid with an agent such as the organic sulphate of formula (R⁷)₂SO₄ or the organic iodide of formula R⁷I: cf. especially Can. J. Chem., 65, 1987, pages 2179-81 and Tetrahedron Letters, No. 9, pages 689-92, 1973;

(2i) the reaction of the chloride of the carboxylic acid with the alcohol of formula R⁷OH in the presence of an amine base: cf. especially Heterocycles, 39, 2, 1994, pages 767-78 and J. Org. Chem., 26, 1961, pages 697-700;

(3i) the reaction of transesterification in the presence of an ester, such as the formate of formula H—COOR⁷: cf. especially Justus Liebigs Ann. Chem., 640, 1961, pages 142-4 and J. Chem. Soc., 1950, pages 3375-7;

(4i) the reaction of methylation by diazomiethane which makes it possible to prepare the methyl ester easily: cf. especially Justus Liebigs Ann. Chem., 488, 1931, pages 211-27;

(5i) the reaction of direct esterification by the alchol R⁷—OH: cf. especially Org. Syn. Coll., Vol 1, pages 237 and 451, 1941 and J.Org. Chem., 52, 1987, page 4689.

According to a second process, which corresponds to a preferred synthesis route, the compounds according to the invention may be prepared by forming an amide functional group by adding an aminosilane 1 to an activated ester derivative 6 obtained from a maleic acid monoester 5, by carrying out the following steps: (1) alcoholysis of the maleic anhydride 2 by the alcohol R⁷—OH, (2) activation of the carboxylic acid functional group of the maleic acid monoester 5 obtained, using the various activation methods described in the peptide synthesis field, in order to result in the activated ester derivative 6, and then (3) the addition of the aminosilane 1 to the said activated ester derivative 6 in order to result in the compound essentially consisting of the desired functionalized organosilane 4, by applying the following synthesis scheme:

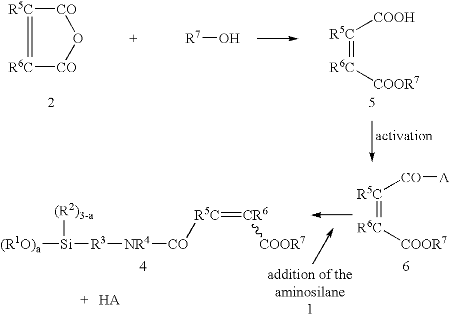

where the symbol A of the derivative 6 represents an activating functional group.

With regard to the practical way of implementing steps (1) to (3), reference may be made for further details to the contents of the following documents which describe, possibly starting with other reactants, operating methods that can be applied to the execution of the various steps of the process in question:

for step (1): cf. especially J. Med. Chem., 1983, 26, pages 174-181;

for steps (2) and (3): cf. John Jones, “Amino Acid and Peptide Synthesis”, pages 25-41, Oxford University Press, 1994.

In order to allow the amine functional group to be added to the carboxylic acid functional group of the maleic acid monoester 5, it is appropriate beforehand to activate the said carboxylic acid functional group and this activation may be carried out, in particular, by using the following methods:

(j) activation by the reaction with an alkylchloroformate, according to the scheme:

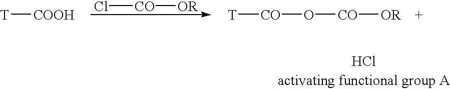

where T represents the —R⁵C=CR⁶—COOR⁷ residue and R represents a linear alkyl radical having, for example, 1 to 3 carbon atoms;

(2j) activation by the reaction with dicyclohexylcarbodiimide (DCCI), preferably in the presence of N-hydroxysuccinimide (HO—SN), according to the scheme:

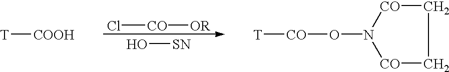

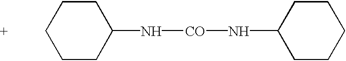

(3j) activation by the reaction with a chlorine compound such as, for example, thionyl chloride or phosphorus pentachloride, according to the scheme:

$$\begin{matrix}T—COOH {\to }^{{PCl}_{5}} T—CO—Cl + {POCl}_{3} + HCl \\ A\end{matrix}$$

Activation methods (j) and (2j) are especially preferred.

As specific examples of organoaminosilanes 1, mention may be made of those of the formulae given below:

(C₂H₅O)₂CH₃Si(CH₂)₃NH₂

(C₂H₅O)₃Si(CH₂)₃NH₂

(CH₃O)₂CH₃Si(CH₂)₃NH₂

(CH₃O)₃Si(CH₂)₃NH₂

(CH₃O)₃Si(CH₂)₄NH₂

(C₂H₅O)₃Si(CH₂)₄NH₂

(CH₃O)₂CH₃SiCH₂CH₂CH(CH₃)CH₂NH₂

(CH₃O)₃Si(CH₂)₃O(CH₂)₃NH₂.

According to the third of its subjects, the present invention also relates to the use of an effective amount of at least one compound essentially consisting of a functionalized organosilane of formula (I) as a white-filler/elastomer coupling agent in the natural or synthetic rubber-type elastomer compositions, comprising a white filler, especially a siliceous material, as reinforcing filler, which compositions are intended for the manufacture of elastomer articles.

The types of elastomer articles in which the invention is most useful are those subject especially to the following stresses: variations in temperature and/or variations in high-frequency stressing in dynamic mode; and/or a high static stress; and/or extensive flexural fatigue in dynamic mode. Such articles are, for example: conveyor belts, power transmission belts, flexible pipes, expansion joints, seals for domestic electrical appliances, supports acting as vibration dampers for engines, either with metal plates or with a hydraulic fluid inside the elastomer, cables, cable jackets, shoe soles and cable-car wheels.

The field of the invention is that of a high-performance use capable of providing elastomer compositions which have, in particular: for great ease of processing the as-prepared compounds, particularly in extrusion and calendering operations, rheological properties marked by the lowest possible viscosity values; in order to achieve excellent productivity of the vulcanization plant, vulcanization times as short as possible; and, in order to withstand the abovementioned operating stresses, excellent reinforcing properties conferred by a filler, in particular optimum values of the tensile elastic modulus, tensile strength and abrasion resistance.

To achieve such an objective, many solutions have been proposed which are essentially concentrated. on the use of one or more elastomers modified by a white filler, especially silica, as reinforcing filler. It is known, in general, that in order to obtain the optimum reinforcing properties imparted by a filler, it is necessary for the latter to be present in the elastomer matrix in a final form which is both as finely divided as possible and distributed as homogeneously as possible. Now, such conditions can be achieved only when the filler can very easily, on the one hand, be incorporated into the matrix during the mixing with the elastomer(s) and be deagglomerated and, on the other hand, be homogeneously dispersed in the elastomer matrix. The use of a single reinforcing white filler, especially a single reinforcing silica, has proved to be unsuitable because of the low level of certain properties of such compositions, and consequently of certain properties of the articles using these compositions.

For reciprocal affinity reasons, the white-filler particles, especially silica particles, have an annoying tendency, in the elastomer matrix, to agglomerate together. These filler/filler interactions have the undesirable consequence of limiting the reinforcing properties to a level substantially below that which it would be theoretically possible to achieve if all the white-filler/elastomer bonds capable of being created during the mixing operation were actually obtained.

In addition, the use of the white filler raises processing difficulties due to the filler/filler interactions which, in the uncured state, tend to increase the viscosity of the elastomer compositions, at the very least so as to make them more difficult to process.

A man skilled in the art knows that it is necessary to use a coupling agent, sometimes called a bonding agent, whose function is to ensure coupling between the surface of the white-filler particles and the elastomer, while at the same time facilitating the dispersion of this white filler within the elastomeric matrix.

The term “coupling” agent (for white-filler/ elastomer coupling) is understood to mean, in a known manner, an agent capable of creating sufficient coupling, of a chemical and/or physical nature, between the white filler and the elastomer; the simplified general formula of such an at least difunctional coupling agent is, for example, “Y-B-X”, in which:

Y represents a functional group (functional group “Y”) capable of physically and/or chemically bonding to the white filler, such a bond possibly being created, for example, between a silicon atom of the coupling agent and the hydroxyl groups (OH) on the surface of the white filler (for example, the surface silanols when the filler is silica);

X represents a functional group (functional group “X”) capable of physically and/or chemically bonding to the elastomer, for example via a sulphur atom;

B represents a hydrocarbon group allowing Y to be linked to X.

Coupling agents must in particular not be confused with simple white-filler coating agents which, in a known manner, may include the functional group Y, which is active with respect to the white filler, but which do not contain the functional group X, which is active with respect to the elastomer.

Coupling agents, especially silica/elastomer coupling agents, have been described in a large number of documents, the most widely known being difunctional alkoxysilanes.

Thus, Patent Application FR-A-2 094 859 has proposed the use of a mercaptosilane to increase the affinity of silica with the elastomer matrix. It has been demonstrated and is nowadays well-known that mercaptosilanes, and in particular γ-mercaptopropyltriethoxysilane, are capable of providing excellent silica/elastomer coupling properties, but that the industrial use of these coupling agents is not possible because of the high reactivity of the —SH functional groups which very rapidly lead, during the preparation of the rubber-type elastomer composition in an internal mixer, to crosslinking reactions during the mixing, also called “scorching”, to high viscosities and, eventually, to compositions which are virtually impossible to work and to process on an industrial scale. To illustrate this impossibility of using such coupling agents and rubber compositions containing them on an industrial scale, mention may be made of documents FR-A-2 206 330 and U.S. Pat. No. 4,002,594.

To remedy this drawback, it has been proposed to replace these mercaptosilanes with polysulphide-type alkoxysilanes, especially bis[tri(C₁-C₄)alkoxylsilyl-propyl] polysulphides as described in many patents or patent applications (see, for example, FR-A-2 206 330, U.S. Pat. No. 3,842,111, U.S. Pat. No. 3,873,489, U.S. Pat. No. 3,978,103 and U.S. Pat. No. 3,997,581). Among these polysulphides, mention may especially be made of bis(3-triethoxysilylpropyl) tetrasulphide (abbreviated to TESPT) which is generally considered today as the product providing, for silica-filled vulcanized compositions, the best compromise in terms of scorch resistance, processability and reinforcing power, but the known drawback of which is that it is very expensive (see, for example, Patents U.S. Pat. No. 5,652,310, U.S. Pat. No. 5,684,171 and U.S. Pat. No. 5,684,172).

In the light of the prior art, it is therefore apparent that there is an unsatisfied need in high-performance uses for coupling agents based on functionalized silanes in elastomer compositions comprising a siliceous material as reinforcing filler, or more generally comprising a reinforcing white filler.

The Applicant has discovered during its research that, unexpectedly, novel coupling agents based on organoxysilanes carrying a particular activated ethylenic double bond, present in the form of a maleamic ester functional group or a fumaramic ester functional group, provide a coupling performance at least equal to that associated with the use of polysulphide-type alkoxysilanes, especially TESPT, and also avoids the premature scorch problems and processing problems associated with an excessively high viscosity of the elastomer compositions in the uncured state, especially specific to mercaptosilanes.

More specifically, the present invention, according to its third subject, relates to the use of an effective amount of at least one compound essentially consisting of a functionalized organosilane of formula (I), obtained by one or other of the processes, also described above, as a white-filler/elastomer coupling agent in natural and/or synthetic elastomer compositions comprising a white filler as reinforcing filler, which are intended for the manufacture of elastomer articles.

Within the context of this coupling agent application, the present invention also relates to elastomer compositions comprising a reinforcing white filler obtained by using an effective amount of at least one compound essentially consisting of a functionalized organosilane of formula (I).

More specifically, these compositions comprise (the parts are given by weight):

per 100 parts of elastomer(s),

10 to 150 parts, preferably 20 to 100 and even more preferably 30 to 80 parts, of reinforcing white filler,

0.5 to 20 parts, preferably 1 to 15 parts and even more preferably 3 to 12 parts, of compound essentially consisting of an organosilane of formula (I), per 100 parts of reinforcing white filler.

In the present specification, the expression “reinforcing white filler” is understood to mean a white filler capable of reinforcing by itself, without means other than a coupling agent, a natural or synthetic rubber-type elastomer composition.

It does not matter in which physical state the reinforcing white filler is in, that is to say the said filler may be in the form of powder, microbeads, granules or balls.

Preferably, the reinforcing white filler consists of silica, alumina or a mixture of these two species.

More preferably, the reinforcing white filler consists of silica, by itself or as a mixture with alumina.

By way of silica capable of being used in the invention, all precipitated or pyrogenic silicas known to those skilled in the art having a BET specific surface area ≦ than/to 450 m²/g are suitable. Precipitated silicas, which may be conventional or highly dispersible, are preferred.

The expression “highly dispersible silica” is understood to mean any silica which is able to deagglomerate and to be very finely dispersed in a polymeric matrix as can be observed on thin cross sections in an electron or optical microscope. As non-limiting examples of highly dispersible silicas, mention may be made of those having a CTAB specific surface area of less than or equal to 450 m²/g and particularly those described in U.S. Pat. No. 5,403,570 and Patent Applications WO-A-95/09127 and WO-A-95/09128, the content of which is incorporated here. Treated precipitated silicas such as, for example, the silicas “doped” with aluminium described in Patent Application EP-A-0 735 088, the content of which is also incorporated here, are also suitable.

More preferably, very suitable are precipitated silicas having:

a CTAB specific surface area ranging from 100 to 240 m²/g, preferably from 100 to 180 m²/g,

a BET specific surface area ranging from 100 to 250 m²/g, preferably from 100 to 190 m²/g,

a DOP oil absorption of less than 300 ml/100 g, preferably ranging from 200 to 295 ml/100 g,

a BET specific surface area/CTAB specific surface area ratio ranging from 1.0 to 1.6.

Of course, the term “silica” is also understood to mean cuts of various silicas. The CTAB specific surface area is determined according to the NFT 45007 (November 1987) method. The BET specific surface area is determined according to the Brunauer, Emmet and Teller method described in “The Journal of the American Chemical Society, Vol. 80, page 309 (1938)” corresponding to the NFT 45007 (November 1987) standard. The DOP oil absorption is determined using dioctyl phthalate according to the NFT 30-022 (March 1953) standard.

As reinforcing alumina, it is advantageous to use a highly dispersible alumina having:

a BET specific surface area ranging from 30 to 400 m²/g, preferably from 80 to 250 m²/g,

a mean particle size of at most equal to 500 nm, preferably at most equal to 200 nm, and

a high content of Al—OH reactive functional groups on the surface,

as described in document EP-A-0 810 258.

As non-limiting examples of such reinforcing aluminas, mention may especially be made of the aluminas A125, CR125, D65CR from Baïkowski.

The coupling agent described above could be pregrafted (via the “Y” functional group) onto the reinforcing white filler, the filler thus “precoupled” possibly being subsequently bonded to the elastomer by means of the “X” free functional group.

Elastomers that can be used for the compositions according to the third subject of the invention are understood to be:

(1) homopolymers obtained by the polymerization of a conjugated diene monomer having from 4 to 22 carbon atoms, such as, for example: 1,3-butadiene, 2-methyl-1,3-butadiene, 2,3-dimethyl-1,3-butadiene, 2,3-diethyl-1,3-butadiene, 2-methyl-3-ethyl-1,3-butadiene, 2-chloro-1,3-butadiene, 2-methyl-3-isopropyl-1,3-butadiene, 1-phenyl-1,3-butadiene, 1,3-pentadiene and 2,4-hexadiene;

(2) copolymers obtained by the mutual copolymerization of at least two of the aforementioned conjugated dienes or by the copolymerization of one or more of the aforementioned conjugated dienes with one or more ethylenically unsaturated monomers chosen from:

aromatic vinyl monomers having from 8 to 20 carbon atoms, such as, for example: styrene, ortho-, meta- or paramethylstyrene, the commercial mixture “vinyl toluene”, paratert-butylstyrene, methoxystyrenes, chlorostyrenes, vinylmycetylene, divinylbenzene and vinylnaphthalene;

vinyl nitrile monomers having from 3 to 12 carbon atoms, such as, for example, acrylonitrile and methacrylonitrile;

acrylic ester monomers derived from acrylic acid or methacrylic acid with alkanols having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate and isobutyl methacrylate;

the copolymers may contain between 99% and 20% by weight of diene units and between 1% and 80% by weight of aromatic vinyl, vinyl nitrile and/or acrylic ester units;

(3) copolymers obtained by the copolymerization of ethylene with an α-olefin having from 3 to 6 carbon atoms, such as, for example, the elastomers obtained from ethylene and propylene (EPR elastomers);

(4) ternary copolymers obtained by the copolymerization of ethylene, an α-olefin having 3 to 6 carbon atoms and an unconjugated diene monomer having from 6 to 12 carbon atoms, such as, for example, the elastomers obtained from ethylene, propylene and an unconjugated diene monomer of the aforementioned type such as, especially, 1,4-hexadiene, ethylidene, norbornene and dicyclopentadiene (EPDM elastomer);

(5) natural rubber;

(6) copolymers obtained by the copolymerization of isobutene and isoprene (butyl rubber) and the halogenated, particularly chlorinated or brominated, versions of these copolymers;

(7) a blend of several of the aforementioned elastomers (1) to (6) together;

(8) chlorosulphonated polyethylenes;

(9) fluorinated hydrocarbons;

(10) elastomers of the epichlorohydrin/ethylene oxide type or polyepichlorohydrin.

Preferably, use is made of one or more elastomers chosen from: (1) polyisoprene [or poly(2-methyl-1,3-butadiene)]; (2) poly(isoprene-butadiene), poly(isoprene-styrene), poly(isoprene-butadiene-styrene); (5) natural rubber; (6) butyl rubber; (7) a blend of the abovenamed elastomers (1), (2), (5), (6) together; (7′) a blend containing a majority amount (ranging from 51% to 99.5% and, preferably, from 70% to 99% by weight) of polyisoprene (1) and/or of natural rubber (5) and a minority amount (ranging from 49% to 0.5% and, preferably, from 30% to 1% by weight) of polybutadiene, polychloroprene, poly(butadiene-styrene) and/or poly(butadiene-acrylonitrile).

The compositions according to the invention may furthermore contain, and this is a preferred aspect, at least one coupling activator capable of activating, that is to say increasing, the coupling function of the coupling agent described above; this coupling activator, used in a very small amount (at most equal to 1 part per 100 parts by weight of elastomer(s)), is a radical initiator of the thermally initiated type.

In a known manner, a radical initiator is an organic compound capable, after being activated by supplying energy, of generating free radicals in situ within its surrounding medium. The radical initiator which may be introduced into the compositions of the invention is an initiator of the thermally initiated type, that is to say one in which the supply of energy, in order to create the free radicals, must be in a thermal form. It is thought that the generation of these free radicals promotes, during the manufacture (thermomechanical mixing) of the rubber compositions, better interaction between the coupling agent and the diene elastomer.

It is preferred to choose a radical initiator whose decomposition temperature is less than 180° C., more preferably less than 160° C., such temperature ranges making it possible to derive full benefit from the activation effect of the coupling, during the manufacture of the compositions of the invention.

The coupling activator, when one is used, is preferably chosen from the group consisting of peroxides, hydroperoxides, azido compounds, bis(azo) compounds, peracids, peresters or a mixture of two or of more than two of these compounds.

More preferably, the coupling activator, when one is used, is chosen from the group consisting of peroxides, bis(azo) compounds, peresters or a mixture of two or of more than two of these compounds. As examples, mention may especially be made of benzoyl peroxide, acetyl peroxide, lauryl peroxide, cumyl peroxide, tert-butyl peroxide, tert-butyl peracetate, tert-butyl hydroperoxide, cumene hydroperoxide, tert-butyl cumyl peroxide, 2,5-dimethyl-2,5-bis(tert-butyl)hex-3-yne peroxide, 1,3-bis(tert-butylisopropyl)benzene peroxide, 2,4-dichlorobenzoyl peroxide, tert-butyl perbenzoate, 1,1-bis(tert-butyl)-3,3,5-trimethylcyclohexane peroxide, 1,1′-azobis(isobutyronitrile) (abbreviated to “AIBN”), 1,1′-azobis(secpentylnitrile) and 1,1′-azobis(cyclohexanecarbonitrile).

According to one particularly preferred embodiment, the radical initiator, when one is used, is 1,1-bis(tert-butyl)-3,3,5-trimethylcyclohexane peroxide. Such a compound is sold, for example, by Flexsys under the name TRIGONOX 29-40 (40% by weight of peroxide on a solid calcium carbonate support).

According to another particularly preferred embodiment, the radical initiator, when one is used, is 1,1′-azobis(isobutyronitrile). Such a compound is sold, for example, by DuPont de Nemours under the name VAZO 64.

As indicated above, the radical initiator, when one is used, is employed in a very small amount in the compositions according to the invention, namely an amount ranging from 0.05 to 1 part, preferably from 0.05 to 0.5 part, and even more preferably from 0.1 to 0.3 part, per 100 parts of elastomer(s).

Of course, the need to use a coupling activator and the optimum content of coupling activator, when one is used, will be determined depending on the particular conditions of realizing the invention, namely on the type of elastomer(s), on the nature of the reinforcing white filler, and on the nature and the amount of coupling agent used. Preferably, the amount of coupling activator, when one is used, represents between 1% and 10%, more preferably between 2% and 6%, by weight with respect to the amount of coupling agent.

The compositions according to the invention furthermore contain all or some of the other constituents and auxiliary additives normally used in the field of elastomer and rubber compositions.

Thus, all or some of the following other constituents and additives may be used:

with regard to the vulcanization system, mention may be made of, for example:

vulcanization agents chosen from sulphur or sulphur-donating compounds such as, for example, thiuram derivatives;

vulcanization accelerators such as, for example, guanidine derivatives, thiazol derivatives or sulphenamide derivatives;

vulcanization activators such as, for example, zinc oxide, stearic acid and zinc stearate;

with regard to other additive(s), mention may be made of, for example:

a conventional reinforcing filler such as carbon black (in this case, the reinforcing white filler used constitutes more than 50% of the weight of the reinforcing white filler + carbon black combination);

a barely reinforcing or non-reinforcing conventional white filler such as, for example, clays, bentonite, talc, chalk, kaolin, titanium dioxide or a mixture of these species;

antioxidants;

antiozonants such as, for example, N-phenyl-N′-(1,3-dimethylbutyl)-p-phenylenediamine;

plasticizers and processing aids.

With regard to processing aids, the compositions according to the invention may contain agents for coating the reinforcing filler, comprising, for example, only the Y functional group, which are capable in a known manner, by an improvement in the dispersion of the filler in the rubber matrix and by a lowering of the viscosity of the compositions, to improve the processability of the compositions in the green or uncured state. Such processing aids consist, for example, in polyols, polyethers (for example, polyethylene glycols), primary, secondary or tertiary amines (for example, trialkanolamines) and α(ω-dihydroxylated polydimethylsiloxanes. Such a processing aid, when one is used, is employed in an amount of 1 to 10 parts by weight, and preferably 2 to 8 parts, per 100 parts of reinforcing white filler.

The process for preparing elastomer compositions comprising a reinforcing white filler and an effective amount of coupling agent may be carried out in a conventional operating mode in one or two steps.

According to the one-step process, all the necessary constituents, with the exception of the vulcanization agent(s) and, possibly, the vulcanization accelerator(s) and/or the vulcanization activator(s), are introduced into and mixed in a standard internal mixer, for example of the BANBURY type or of the BRABENDER type. The result of this first mixing step is mixed further on an external mixer, generally a two-roll mill, and then the vulcanization agent(s) and, possibly, the vulcanization accelerator(s) and/or the vulcanization activator(s) are added to it.

It may be advantageous for the preparation of certain articles to employ a two-step process, both steps being carried out in an internal mixer. In the first step, all the necessary constituents, with the exception of the vulcanization agent(s) and, possibly, the vulcanization accelerator(s) and/or the vulcanization activator(s), are introduced and mixed. The object of the second step which follows is essentially to make the mixture undergo a complementary heat treatment. The result of this second step is then also further mixed on an external mixer in order to add thereto the vulcanization agent(s) and, possibly, the vulcanization accelerator(s) and/or the vulcanization activator(s).

The work phase in the internal mixer is generally carried out at a temperature ranging from 80° C. to 200° C., preferably from 80° C. to 180° C. This first work phase is followed by the second work phase in the external mixer, operating at a lower temperature, generally of less than 120° C. and preferably ranging from 25° C. to 70° C.

The final composition obtained is then calendered, for example, in the form of a sheet, of a plate or of a profile that can be used for the manufacture of elastomer articles.

The vulcanization (or curing) is carried out in a known manner at a temperature generally ranging from 130° C. to 200° C. for a sufficient time which may vary, for example between 5 and 90 minutes, depending especially on the curing temperature, on the vulcanization system adopted and on the vulcanization kinetics of the composition in question.

It goes without saying that the present invention, according to its third subject, relates to the elastomer compositions described above both in the green state (i.e. before curing) and in the cured state (i.e. after crosslinking or vulcanization).

The elastomer compositions serve for producing elastomer articles having a body comprising the said compositions. These compositions are particularly useful for producing articles consisting of engine mounts, shoe soles, cable-car wheels, seals for domestic electrical appliances, and cable jackets.

The following examples illustrate the present invention.

### EXAMPLE 1

This example describes the preparation of a compound essentially consisting of an alkoxysilane of formula (I) comprising a maleamic ester functional group, employing the synthesis route passing via an activated ester derivative (second process according to the invention).

### 1) Alcoholysis of the Maleic Anhydride:

The maleic anhydride (698.1 g, i.e. 7.12 mol) was introduced into a 2-litre four-necked reactor and then melted by heating the reactor using an oil bath raised to 70° C. Once all the anhydride had melted, the methanol (221.4 g, i.e. 6.92 mol) was introduced, with stirring, via a dropping funnel. Next, the mixture was left, with stirring, for 20 hours at 23° C., then devolatilized by applying a reduced pressure of 10×10² Pa for 1 hour and finally filtered on a filter paper. Thus, 786.9 g of maleic acid monomethylester, of the following formula, was recovered (with a yield of 86%):

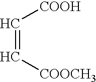

### Preparation of the Activated Ester Derivative, and then Coupling with the Aminosilane:

The maleic acid monomethylester (219.7 g, i.e 1.685 mol) was introduced into a 2-litre three-necked reactor, fitted with a mechanical stirrer and with a condenser and placed in an argon atmosphere, and then dissolved in dichloromethane CH₂Cl₂ (950 g) The reaction mixture was cooled to −60° C. and then N-methylmorpholine (187.58 g, i.e. 1.854 mol) was gradually added over a period of 4 minutes. After this time, ethylchloroformate Cl—CO—OC₂H₅ (201.21 g, i.e. 1.854 mol) was gradually introduced dropwise over a period of 10 minutes, operating at this same temperature of −60° C.

The reaction mixture thus obtained, which contained the activated ester derivative of formula:

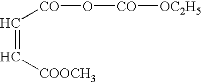

was left for 10 minutes at the temperature at which it was at.

Next, the aminosilane of formula (C₂H₅O)₂CH₃Si(CH₂)₃NH₂ (322.43 g, i.e. 1.685 mol) was gradually introduced dropwise over 15 minutes via a dropping funnel. The reaction mixture was left with stirring, allowing the temperature of the mass to rise gently back up to the ambient temperature of 23° C. Once the mixture had reached the ambient temperature, it was again stirred for 2 hours at this temperature, then it was filtered on a glass frit and finally the solvent was removed by evaporation.

The residual compound obtained was then purified by chromatography over a silica gel using a 50/50 by volume heptane/ethyl acetate mixture as eluant; the eluant was then removed by evaporation.

The purified compound obtained was subjected to proton NMR analysis and silicon (²⁹Si) NMR analysis. The results of these analyses show that the compound obtained contained (the molar percentages indicated below express the number of organosiliceous units per 100 silicon atoms present in the compound obtained):

81.9 mol % of coded unit D(OC₂H₅)₂ of formula CH₃ZSi(OC₂H₅)₂ belonging to the silane having a maleamic ester functional group (present in an amount of 83.2% by weight) of formula:

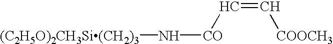

9.1 mol % of coded unit D(OC₂H₅)₂ of formula CH₃ZSi(OC₂H₅)₂ belonging to the silane having a fumeramic ester functional group (present in an amount of 9.2% by weight) of formula:

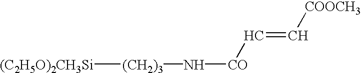

and 9 mol % of coded units D(OC₂H₅) and D of formulae CH₃Z(OC₂H₅)SiO_{1/2} and CH₃ZsiO_{2/2} belonging to the oligomer (present in an amount of 7.6% by weight) of formula:

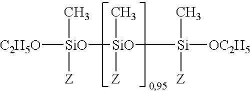

where Z=(CH₂)₃—NH—CO—CH=CH—COOCH₃.

### EXAMPLES 2 and 3

The purpose of these examples is to demonstrate, on the one hand, the improved (white-filler/diene-elastomer) coupling performance of a compound essentially consisting of an alkoxysilane of formula (I) carrying a maleamic ester functional group, used by itself and, on the other hand, the possibility of enhancing this improved coupling performance by using the aforementioned coupling agent which is combined with a peroxide as a thermally initiated radical initiator. This performance was compared with that of a conventional coupling agent, namely TESPT (or bis(3-triethoxysilylpropyl) tetrasulphide).

4 diene elastomer compositions representative of formulations for shoe soles are compared. These 4 compositions are identical, apart from the following differences:

composition No. 1 (control 1): TESPT coupling agent (4 per cent or parts by weight per 100 parts of elastomers) used alone;

composition No. 2 (control 2): TESPT (4 per cent) combined with 0.12 per cent of peroxide;

composition No. 3 (Example 2): compounds which essentially consists of an alkoxysilane of formula (I) consisting, in the methyl ester, of N-[γ-propyl(methyldiethoxy)silane]maleamic acid (5.3 per cent), used alone;

composition No. 4 (Example 3): a coupling agent of composition No. 3 (5.3 per cent) combined with 0.12 per cent of peroxide.

### 1) Formulation of the Diene Elastomer Compositions

The following compositions, the formulation of which, expressed in parts by weight, is indicated in Table I given below, were prepared in an internal mixer of the BRABENDER type:

TABLE I

| | | Control | Control | Example | Example |
|---|---|---|---|---|---|
| Composition | | 1 | 2 | 2 | 3 |
| NR rubber | (1) | 85 | 85 | 85 | 85 |
| BR 1220 rubber | (2) | 15 | 15 | 15 | 15 |
| Silica | (3) | 50 | 50 | 50 | 50 |
| Zinc oxide | (4) | 5 | 5 | 5 | 5 |
| Stearic acid | (5) | 2 | 2 | 2 | 2 |
| TESPT silane | (6) | 4 | 4 | — | — |
| Maleamic ester silane | (7) | — | — | 5.3 | 5.3 |
| compound | | | | | |
| TBBS | (8) | 2 | 2 | 2 | 2 |
| DPG | (9). | 1.4 | 1..4 | 1.4 | 1.4 |
| Sulphur | (10) | 1.7 | 1.7 | 1.7 | 1.7 |
| Pure peroxide | (11) | — | 0.12 | — | 0.12 |

(1) Natural rubber, of Malaysian origin, sold by Safic-Alcan under the reference SMR 5L;

(2) Polybutadiene rubber having a high content of cis-1,4 addition products, sold by SMPC;

(3) Zeosil 1165 MP silica, sold by Rhodia-Silices;

(4) and (5) Vulcanization activators;

(6) bis(3-Triethoxysilylpropyl) tetrasulphide, sold by Degussa under the name Si-69;

(7) A compound essentially consisting of an alkoxysilane having an activated double bond of formula (I) consisting of the methyl ester of N-[γ-propyl(methyl-diethoxy)silane] maleamic acid, prepared as indicated above in Example 1);

(8) N-tert-2-Butyl-benzothiazyl sulphenamide (vulcanization accelerator);

(9) Diphenyl guanidine (vulcanization accelerator);

(10) Vulcanization agent;

(11) 1,1-bis(tert-Butyl)-3,3,5-trimethylcyclohexane peroxide, sold by Flexsys under the name TRIGONOX 29-40, which contains 40% by weight of pure peroxide deposited on a solid calcium carbonate support; the amount indicated in Table I corresponds to the actual proportion of peroxide taken in the pure state, i.e. without the calcium carbonate support.

### 2. Preparation of the Compositions:

The various constituents were introduced into an internal mixer of the BRABENDER type in the order, at the times and at the temperatures indicated below:

| Time | Temperature | Constituents |
|---|---|---|
| 0 minute | 90° C. | NR rubber |
| 1 minute | | BR rubber |
| 2 minutes | 105° C. | 2/3 silica + TESPT silane |
| | | or maleamic ester silane |
| | | + peroxide (when it is |
| | | used) compound |
| 4 minutes | 120° C. | 1/3 silica + stearic acid |
| | | + zinc oxide |

The contents of the mixer were drained or dropped after 5 minutes. The temperature reached was in the range from 140 to 145° C.

The mixture obtained was then put onto a two-roll mill, maintained at 30° C., and the TBBS, DPG and sulphur were introduced. After homogenization, the final mixture was calendered in the form of sheets from 2.5 to 3 mm in thickness.

### 3. Rheological Properties of the Compositions:

The measurements were made on the compositions in the uncured state. Table II below gives the results relating to the rheology test which was carried out at 160° C. for 30 minutes using a MONSANTO 100 S rheometer.

According to this test, the composition to be tested was placed in the test chamber, regulated to the temperature of 160° C., and the resistive torque, opposed by the composition, was measured for a low-amplitude oscillation of a biconical rotor included within the test chamber, the composition completely filling the chamber in question. From the curve of variation in torque as a function of time, the following are determined: the minimum torque which is representative of the viscosity of the composition at the temperature in question; the maximum torque and the delta-torque which are representative of the degree of crosslinking caused by the action of the vulcanization system; the T-90 time needed to obtain a vulcanization state corresponding to 90% of complete vulcanization (this time is taken as being the vulcanization optimum); and the scorch time TS-2 corresponding to the time needed to have an increase of 2 points above the minimum torque at the temperature in question (160° C.) and which is representative of the time during which it is possible to use the uncured compounds at this temperature without having to initiate the vulcanization.

The results obtained are given in Table II.

TABLE II

| MONSANTO Rheology | Control 1 | Control 2 | Example 2 | Example 3 |
|---|---|---|---|---|
| Minimum torque | 12.8 | 12.3 | 9.2 | 10 |
| Maximum torque | 105 | 106 | 98 | 99 |
| Delta-torque | 94.2 | 95.7 | 88.8 | 90 |
| TS-2 (minutes) | 3.5 | 3 | 2 | 1.75 |
| TS-90 (minutes) | 6.8 | 6.6 | 4 | 3.7 |

### 4) Mechanical Properties of the Vulcanized Compositions:

The measurements were made on the optimally vulcanized compositions (temperature: 160° C.; durations for each composition: T-90 times indicated in Table II).

The properties measured and the results obtained are given in Table III below:

TABLE III

| Mechanical | | | | | |
|---|---|---|---|---|---|
| properties | | Control 1 | Control 2 | Example 2 | Example 3 |
| 10% modulus | (1) | 0.80 | 0.82 | 0.90 | 0.81 |
| 100% modulus | (1) | 2.5 | 2.65 | 2.7 | 2.9 |
| 300% modulus | (1) | 10.5 | 10.9 | 11 | 13.5 |
| 400% modulus | (1) | 15.8 | 16.4 | 16.7 | 20.9 |
| Elongation at break | (1) | 610 | 540 | 595 | 475 |
| Tensile strength | (1) | 27.9 | 25 | 29 | 26 |
| Reinforcement | | | | | |
| indices: | | | | | |
| 300% M/100% N | | 4.2 | 4.1 | 4.1 | 4.6 |
| 400% M/l00% N | | 6.3 | 6.2 | 6.2 | 7.2 |
| Shore A hardness | (2) | 71 | 72 | 75 | 72 |
| Abrasion resistance | (3) | 121 | 120 | 103 | 93 |

(1) The tensile tests were carried out in accordance with the information in the NF T 46-002 standard on H2-type test pieces. The 10%, 100%, 300% and 400% moduli and the tensile strength are expressed in MPa; the elongation at break is expressed in %.

(2) The measurement was made according to the information in the ASTM D 3240 standard. The value given was measured at 15 seconds.

(3) The measurement was made according to the information in the NF T 46-012 standard using method 2 with a rotating test-piece holder. The measured value is the loss of substance (in mm³) by abrasion; the lower this value, the better the abrasion resistance.

Examination of the various results in Tables II and III leads to the following observations. In terms of the uncured compounds, the compositions according to the invention (Examples 2 and 3) have low minimum torques, which means that there is good dispersion of the silica filler and no scorching during the processing.

After curing, the compositions according to the invention (cf. Examples 2 and 3) have abrasion resistances which are significantly superior to those obtained with compositions coupled with TESPT, and the peroxide significantly enhances this property. In the presence of peroxide, the composition according to the invention (cf. Example 3) has the highest values of modulus at high strain (M 300 and M 400) and of reinforcement indices. All these highest values, in terms of abrasion resistance, modulus at high strain and reinforcement index, are indicators, known to those skilled in the art, of a significant improvement in the white-filler/elastomer coupling due to the coupling agent(s) according to the invention, used by itself (or themselves) or in combination with a coupling activator.

1. Compounds essentially consisting of a functionalized organosilane of formula: 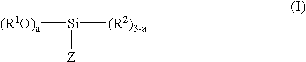
in which:
the symbols R¹, which are identical or different, each represent a monovalent hydrocarbon group chosen from: a linear or branched alkyl radical having from 1 to 4 carbon atoms; a linear or branched alkoxyalkyl radical having from 2 to 6 carbon atoms; a cycloalkyl radical having from 5 to 8 carbon atoms; and a phenyl radical;
the symbols R², which are identical or different, each represent a monovalent hydrocarbon group chosen from: a linear or branched alkyl radical having from 1 to 6 carbon atoms; a cycloalkyl radical having from 5 to 8 carbon atoms; and a phenyl radical;
Z is a functional group, comprising an activated ethylenic double bond, chosen from:
a maleamic ester functional group Z² of formula: 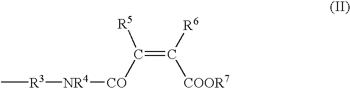
and a fumaramic ester functional group Z³ of formula: 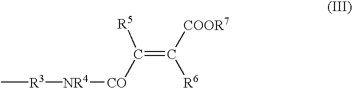
in which formulae:
R³ is a divalent, linear or branched, alkylene hydrocarbon radical having from 1 to 10 carbon atoms, possibly interrupted by at least one oxygen-substituted heteroatom whose free valence carried by a carbon atom is linked to the Si atom;
the symbols R⁴, R⁵ and R⁶, which are identical to or different from one another, each represent a hydrogen atom or a monovalent hydrocarbon group chosen from: a linear or branched alkyl radical having from 1 to 6 carbon atoms; and a phenyl radical;
R⁷ is a monovalent hydrocarbon group chosen from: a linear or branched alkyl radical having from 1 to 6 carbon atoms; and a phenyl radical;
a is a number chosen from 1, 2 and 3.

2. Compounds according to claim 1, characterized in that, in formula (I):
the radicals R¹ are chosen from the radicals: methyl, ethyl, n-propyl, isopropyl, n-butyl, CH₃OCH₂—, CH₃OCH₂CH₂— and CH₃OCH(CH₃)CH₂—;
the radicals R² are chosen from the radicals: methyl, ethyl, n-propyl, isopropyl, n-butyl, n-pentyl, cyclohexyl and phenyl;
the functional groups represented by the symbol Z are chosen from the functional groups of formulae (II) and (III), in which:
the symbol R³ represents an alkylene residue which satisfies the following formulae: —(CH₂)₂—, —(CH₂)₃—, —(CH₂)₄—, —CH₂—CH(CH₃)—, —(CH₂)₂—CH(CH₃)—(CH₂)—, —(CH₂)₃—O—(CH₂)₃— and —(CH₂)₃—)—CH₂—CH(CH₃)—CH₂—;
the symbols R⁴, R⁵ and R⁶ are chosen from: a hydrogen atom, and methyl, ethyl, n-propyl and n-butyl radicals;
the symbol R⁷ is chosen from methyl, ethyl, n-propyl and isopropyl radicals.

3. Compounds according to claim 2, characterized in that the functionalized organosilanes satisfying formula (I) are those of formula: 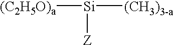
where:
a is a number equal to 2 or 3,
the symbol Z satisfies the following formulae (II) and (III):

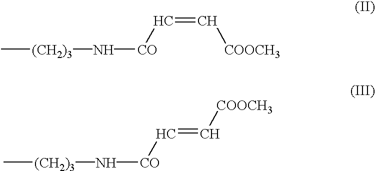

4. Compounds according to any one of claims 1 to 3, characterized in that they are in the form of a functionalized organosilane of formula (I) in the pure state or in the form of a mixture of a like organosilane with an amount less than or equal to 40 mol % in the mixture of one or more other organosiliceous compounds, comprising:
in an amount less than or equal to 10 mol %: the functionalized organosilane of formula (I) which is the isomer of the organosilane essentially obtained, that is to say the trans organosilane of formula (I) where Z is the functional group Z³ of formula (III), when the organosilane essentially obtained is the cis organosilane of formula (I) where Z is the functional group Z² of formula (II), and vice versa; and/or
in an amount equal to or less than 30 mol %: at least one linear, cyclic and/or networked siloxane oligomer formed from units satisfying the following formulae: (R⁸)₂ZSiO_{1/2} (IV-1), R⁸ZSiO_{2/2} (IV-2) and/or ZSiO_{3/2} (IV-3), in which: the symbols R⁸, which are identical or different, each represent a monovalent radical chosen from the hydroxyl radical and/or the radicals satisfying the definitions of OR¹ and R²; the symbols R¹, R² and Z are as defined above; and the total number of units of formulae (IV-1) to (IV-3), per oligomer molecule, is an integer or fractional number greater than 1.

5. Process for the preparation of the compounds according to any one of claims 1 to 4, characterized in that the said compounds are prepared by the esterification of the intermediate maleamic acid derivative by carrying out the following steps: (1) the reaction of coupling between an aminosilane 1 and the maleamic anhydride 2, and then (2) the reaction of esterification of the maleamic acid derivative formed 3 so as to result in the compound essentially consisting of the desired functionalized organosilane 4, by applying the following synthesis scheme: 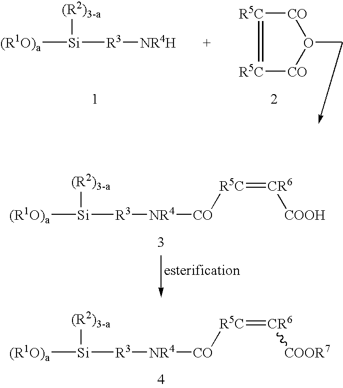
where the symbols R¹ to R⁷ and a have the meanings given above in any one of claims 1 to 3.

6. Process for the preparation of the compounds according to any one of claims 1 to 4, characterized in that the said compounds are prepared by forming an amide functional group by adding an aminosilane 1 to an activated ester derivative 6 obtained from a maleic acid monoester 5, by carrying out the following steps: (1) alcoholysis of the maleic anhydride 2 by the alcohol R⁷—OH, (2) activation of the carboxylic acid functional group of the maleic acid monoester 5 obtained, using the various activation methods described in the peptide synthesis field, in order to result in the activated ester derivative 6, and then (3) the addition of the aminosilane 1 to the said activated ester derivative 6 in order to result in the compound essentially consisting of the desired functionalized organosilane 4, by applying the following synthesis scheme: 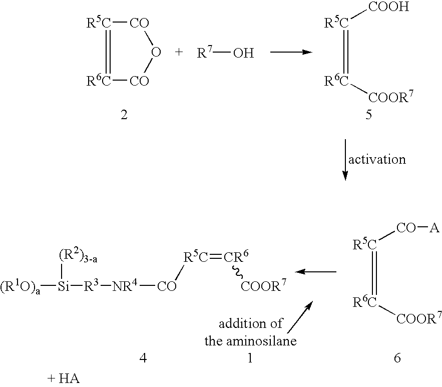
where the symbol A of the derivative 6 represents an activating functional group and where the symbols R¹ to R⁷ and a have the meanings given above in any one of claims 1 to 3.

7. Process according to claim 6, characterized in that the activation of the carboxylic acid functional group of the maleic acid monoester 5 is carried out by using the following methods:
(j) activation by the reaction with an alkylchloroformate, according to the scheme: 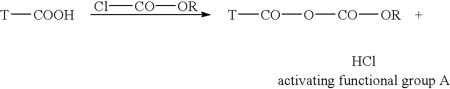
where T represents the —R⁵C=CR⁶—COOR⁷ residue and R represents a linear alkyl radical having, for example, 1 to 3 carbon atoms;
(2j) activation by the reaction with dicyclohexylcarbodiimide (DCCI), in the presence of N-hydroxysuccinimide (HO—SN), according to the scheme:

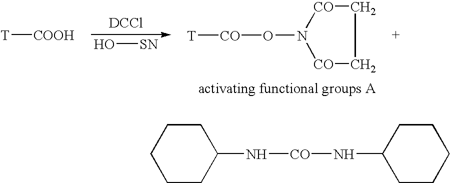

8. Use of an effective amount of at least one compound essentially consisting of a functionalized organosilane of formula (I) according to any one of claims 1 to 4 and/or of at least one compound essentially consisting of an organosilane of formula (I) obtained by the process according to any one of claims 5 to 7, as a white-filler/elastomer coupling agent in the natural or synthetic rubber-type elastomer compositions, comprising a white filler as reinforcing filler, which compositions are intended for the manufacture of elastomer articles.

9. Elastomer compositions comprising a reinforcing white filler, these being obtained by using an effective amount of at least one compound essentially consisting of a functionalized organosilane of formula (I) according to any one of claims 1 to 4 and/or of at least one compound essentially consisting of an organosilane of formula (I) obtained by the process according to any one of claims 5 to 7.

10. Compositions according to claim 9, characterized in that they comprise (the parts are given by weight):
per 100 parts of elastomer(s),
10 to 150 parts of reinforcing white filler,
0.5 to 20 parts of compound essentially consisting of an organosilane of formula (I), per 100 parts of reinforcing white filler.

11. Compositions according to claim 10, characterized in that they comprise:
per 100 parts of elastomer(s),
20 to 100 parts of white filler,
1 to 15 parts of compound essentially consisting of an organosilane of formula (I), per 100 parts of white filler.

12. Compositions according to any one of claims 9 to 11, characterized in that the reinforcing white filler consists of silica, alumina or a mixture of these two species.

13. Compositions according to claim 12, characterized in that:
the silica is a conventional or highly dispersible precipitated silica, especially having a BET specific surface area < than/to 450 m²/g;
the alumina is a highly dispersible alumina, especially having a BET specific surface area ranging from 30 to 400 m²/g and a high content of Al—OH reactive functional groups on the surface.

14. Compositions according to any one of claims 9 to 13, characterized in that the elastomer(s) is (are) chosen from:
(1) homopolymers obtained by the polymerization of a conjugated diene monomer having from 4 to 22 carbon atoms;
(2) copolymers obtained by the mutual copolymerization of at least two of the aforementioned conjugated dienes or by the copolymerization of one or more of the aforementioned conjugated dienes with one or more ethylenically unsaturated monomers chosen from:
aromatic vinyl monomers having from 8 to 20 carbon atoms;
vinyl nitrile monomers having from 3 to 12 carbon atoms;
acrylic ester monomers derived from acrylic acid or methacrylic acid with alkanols having from 1 to 12 carbon atoms;
the copolymers may contain between 99% and 20% by weight of diene units and between 1% and 80% by weight of aromatic vinyl, vinyl nitrile and/or acrylic ester units;
(3) copolymers obtained by the copolymerization of ethylene with an α-olefin having from 3 to 6 carbon atoms;
(4) ternary copolymers obtained by the copolymerization of ethylene, an α-olefin having 3 to 6 carbon atoms and an unconjugated diene monomer having from 6 to 12 carbon atoms;
(5) natural rubber;
(6) copolymers obtained by the copolymerization of isobutene and isoprene (butyl rubber) and the halogenated versions of these copolymers;
(7) a blend of several of the aforementioned elastomers (1) to (6) together;
(8) chlorosulphonated polyethylenes;
(9) fluorinated hydrocarbons;
(10) elastomers of the epichlorohydrin/ethylene oxide type or polyepichlorohydrin.

15. Compositions according to claim 14, characterized in that use is made of one or more elastomers chosen from: (1) polyisoprene [or poly(2-methyl-1,3-butadiene)]; (2) poly(isoprene-butadiene), poly(isoprene-styrene), poly(isoprene-butadiene-styrene); (5) natural rubber; (6) butyl rubber; (7) a blend of the abovenamed elastomers (1), (2), (5), (6) together; (7′) a blend containing a majority amount (ranging from 51% to 99.5% and, preferably, from 70% to 99% by weight) of polyisoprene (1) and/or of natural rubber (5) and a minority amount (ranging from 49% to 0.5% and, preferably, from 30% to 1% by weight) of polybutadiene, polychloroprene, poly(butadiene-styrene) and/or poly(butadiene-acrylonitrile).

16. Compositions according to any one of claims 9 to 15, characterized in that they furthermore contain at least one coupling activator capable of activating, that is to say of increasing, the coupling function of the coupling agent; this coupling activator, used in a very small amount ranging from 0.05 to 1 part per 100 parts by weight of elastomer(s), being a radical initiator of the thermally initiated type.

17. Compositions according to claim 16, characterized in that the coupling activator(s) is(are) chosen from the group consisting of peroxides, hydroperoxides, azido compounds, bis(azo) compounds, peracids, peresters or a mixture of two or of more than two of these compounds.

18. Compositions according to claim 16 or 17, characterized in that the coupling activator(s) is(are) used in proportions ranging from 0.05 to 0.5 part per 100 parts of elastomer(s).

19. Compositions according to any one of claims 9 to 18, characterized in that they furthermore contain all or some of the other constituents and auxiliary additives normally used in the field of elastomer and rubber compositions, the said other constituents and additives comprising:
with regard to the vulcanization system:
vulcanization agents;
vulcanization accelerators;
vulcanization activators;
with regard to other additive(s):
a conventional reinforcing filler such as carbon black;
a barely reinforcing or non-reinforcing conventional white filler;
antioxidants;
antiozonants;
plasticizers and processing aids.

20. Process for the preparation of diene elastomer compositions according to any one of claims 9 to 19, characterized in that:
all the necessary constituents, with the exception of the vulcanization agent(s) and, possibly, the vulcanization accelerator(s) and/or the vulcanization activator(s), are introduced into and mixed in a standard internal mixer, in one or two steps, at a temperature ranging from 80° C. to 200° C.;
then the mixture thus obtained is mixed further on an external mixer and the vulcanization agent(s) and, possibly, the vulcanization accelerator(s) and/or the vulcanization activator(s) are then added thereto, at a lower temperature, below 120° C.

21. Elastomer articles, characterized in that they have a body comprising a composition according to any one of claims 9 to 19.

22. Articles according to claim 21, characterized in that they consist of engine mounts, shoe soles, cable-car wheels, seals for domestic electrical appliances and cable jackets.

23. Novel products, which can be used in the formulation of the compounds essentially consisting of a functionalized organosilane of formula (I), which have been defined above in claim 4, characterized in that they consist of linear, cyclic and/or networked siloxane oligomers or mixtures of such oligomers formed from units satisfying the following formulae: (R⁸)₂ZSiO_{1/2}(VI-1), R⁸ZSiO_{2/2} (VI-2) and/or ZSiO_{3/2} (VI-3) in which: the symbols R⁸, which are identical or different, each represent a monovalent radical chosen from the hydroxyl radical and/or the radicals satisfying the definitions of OR¹ and R²; the symbols R¹, R² and Z are as defined above; and the total number of units of formulae (VI-1) to (VI-3), per oligomer molecules is an integer or fractional number greater than 1.
